(19) United States
(12) Patent Application Publication
(10) Pub. No.: US 2025/0054718 A1
(43) Pub. Date: Feb. 13, 2025

(54) ELECTROMAGNETIC CONTACTOR, INTER-CONTACT GAP ADJUSTMENT METHOD OF ELECTROMAGNETIC CONTACTOR, AND STROKE AMOUNT CALCULATION METHOD AND WIPE AMOUNT CALCULATION METHOD OF ELECTROMAGNETIC CONTACTOR

(71) Applicant: FUJI ELECTRIC CO., LTD., Kawasaki-shi (JP)

(72) Inventors: Koujun KONISHI, Kounosu-city (JP); Takashi TSUTSUMI, Kounosu-city (JP); Yuya SAKURAI, Kounosu-city (JP); Yuma KUSANO, Kounosu-city (JP)

(73) Assignee: FUJI ELECTRIC CO., LTD., Kawasaki-shi (JP)

(21) Appl. No.: 18/752,333

(22) Filed: Jun. 24, 2024

(30) Foreign Application Priority Data
Aug. 9, 2023 (JP) 2023-130042

(51) Int. Cl. H01H 50/54; H01H 49/00; H01H 50/02; H01H 50/16

(52) U.S. Cl. CPC H01H 50/54; H01H 49/00; H01H 50/02; H01H 50/16

(57) ABSTRACT

An electromagnetic contactor comprises: fixed contact pieces 3 including fixed contacts 9; an electromagnet unit 5 to which a movable contact piece 4, the movable contact piece 4 including movable contacts 10, the movable contacts 10 coming into contact with and being separated from the fixed contacts, is joined via a contact support 11; and a hermetically sealed container 2 configured to contain the fixed contact pieces, the movable contact piece, and the electromagnet unit in the same space, wherein in the electromagnet unit 5, unit-side joining portions 25a and 25b, the unit-side joining portions 25a and 25b being joined to container-side joining portions 33 and 36 arranged on the hermetically sealed container from the direction of movement of the movable contact piece, respectively, are arranged, and flat plate-shaped spacers 34 and 37 by which an inter-contact gap G between the fixed contacts and the movable contacts is adjusted are arranged interposed between the container-side joining portion and the unit-side joining portion.

### CROSS-REFERENCE TO RELATED APPLICATION

This application claims benefit of priority under 35 USC 119 based on Japanese Patent Application No. 2023-130042, filed on Aug. 9, 2023, the entire contents of which are incorporated by reference herein.

### TECHNICAL FIELD

The present invention relates to an electromagnetic contactor the inter-contact gap of which can be adjusted, an inter-contact gap adjustment method of the electromagnetic contactor, and a stroke amount calculation method and a wipe amount calculation method of the electromagnetic contactor.

### BACKGROUND ART

For example, an electromagnetic contactor described in PATENT DOCUMENT 1 includes: fixed contact pieces including fixed contacts; an electromagnet unit to which a movable contact piece, the movable contact piece including movable contacts, the movable contacts coming into contact with and being separated from the fixed contacts, is joined via a contact support; and a hermetically sealed container configured to contain the fixed contact pieces, the movable contact piece, and the electromagnet unit in the same space. The electromagnetic contactor is configured such that by an arc generated between the fixed contacts and the movable contacts being stretched in a large arc-extinguishing space in the hermetically sealed container, breaking performance is improved.

For the electromagnetic contactor, various values including an inter-contact gap between the fixed contacts and the movable contacts, a stroke amount, and a wipe amount of a contact spring installed on the contact support are set.

### CITATION LIST

### Patent Literature

PATENT DOCUMENT 1: JP 2023-81586 A

### SUMMARY OF INVENTION

### Technical Problem

An operation to adjust an inter-contact gap to a proper value in order to improve breaking performance, vibration resistance, and impact resistance of the electromagnetic contactor has conventionally been an operation requiring a lot of time to form components the dimensional precisions of which are improved. Further, an operation to set a stroke amount and an operation to set a wipe amount have also been operations requiring a lot of time. Hence, there is a problem in terms of a manufacturing cost of the electromagnetic contactor.

Accordingly, an object of the present invention is to provide an electromagnetic contactor and an inter-contact gap adjustment method of the electromagnetic contactor that enable an inter-contact gap to be set to a proper value by a simple assembly operation even when some variation exists in dimensions of constituent components and reduction in a manufacturing cost to be achieved.

Further, another object of the present invention is to provide a stroke amount calculation method and a wipe amount calculation method of the electromagnetic contactor that enable a stroke amount and a wipe amount to be set by a simple operation.

### Solution to Problem

In order to achieve the above-described object, an electromagnetic contactor according to one aspect of the present invention includes: a fixed contact piece including a fixed contact; an electromagnet unit to which a movable contact piece, the movable contact piece including a movable contact, the movable contact coming into contact with and being separated from the fixed contact, is joined via a contact support; and a hermetically sealed container configured to contain the fixed contact piece, the movable contact piece, and the electromagnet unit in a same space. In the electromagnet unit, a unit-side joining portion being joined to a container-side joining portion arranged on the hermetically sealed container from a direction of movement of the movable contact piece, is arranged, and a flat plate-shaped spacer by which an inter-contact gap between the fixed contact and the movable contact is adjusted is arranged interposed between the container-side joining portion and the unit-side joining portion. Further, a method of adjusting an inter-contact gap in an electromagnetic contactor, which includes a fixed contact piece and an electromagnet unit operatively jointed to a movable contact piece, comprising: measuring, in a state that the electromagnet unit is not excited, first distance L1 in a direction of movement of the movable contact piece and between a first surface of a unit-side joining portion of the electromagnet unit and a movable contact of the movable contact piece; measuring second distance L2 in the direction of movement of the movable contact piece and between a second surface of a container-side joining portion and a fixed contact of the fixed contact piece, the container-side joining portion being arranged on a container configured to contain the fixed contact piece, the movable contact piece, and the electromagnet unit; providing a spacer having thickness T determined by an equation (a) below:

$$T = Gt - ( L 2 - L 1 ) , \qquad ( a )$$

where Gt is a target value of an inter-contact gap between the fixed contact and the movable contact; and joining the container-side joining portion and the unit-side joining portion by interposing the spacer determined to thickness T.

Further, a method of calculating stroke amount of an electromagnetic contactor comprises: measuring the first distance L1 as described above; and before joining the electromagnet unit to the container, measuring, in a state that the electromagnet unit is excited, third distance L3 between the first surface of the unit-side joining portion, and the movable contact in a direction of movement of the movable contact piece; and
calculating stroke amount S by an equation (b) below:

$$S = L 3 - L 1. \qquad ( b )$$

Further, a wipe amount calculation method of an electromagnetic contactor includes calculating a wipe amount W, using a target value Gt of an inter-contact gap used in the above-described inter-contact gap adjustment method of the electromagnetic contactor and a stroke amount S calculated in the above-described stroke amount calculation method of the electromagnetic contactor, by an equation (c) below:

$$W = S - Gt . \qquad ( c )$$

### Advantageous Effects of Invention

According to the electromagnetic contactor and the inter-contact gap adjustment method of the electromagnetic contactor according to the present invention, by only performing assembly of constituent components in a regular operation without improving dimensional precision of the constituent components, an inter-contact gap can be set to a proper value and reduction in a manufacturing cost can be achieved.

Further, according to the stroke amount calculation method and the wipe amount calculation method of the electromagnetic contactor according to the present invention, a stroke amount and a wipe amount can be set by a simple operation.

### BRIEF DESCRIPTION OF DRAWINGS

FIG. 1 is a cross-sectional view illustrative of an electromagnetic contactor according to the present invention.

FIG. 2 is an exploded perspective view illustrative of a state in which unit-side joining portions of an electromagnet unit are joined to container-side joining portions arranged on a capsule case of the electromagnetic contactor according to the present invention with spacers interposed between the unit-side joining portions and the container-side joining portions.

FIG. 3 is a diagram illustrative of measurement of first distance of the electromagnet unit and second distance of the capsule case in order to select the spacers having a predetermined thickness.

FIG. 4 is a diagram illustrative of the electromagnet unit in a non-excited state and an excited state for measuring a stroke amount of the electromagnetic contactor.

### DESCRIPTION OF EMBODIMENTS

An embodiment according to the present invention will be described below with reference to the drawings. In the following description of the drawings, the same or similar reference signs are assigned to the same or similar portions. However, it should be noted that the drawings are schematic and relations between thicknesses and planar dimensions, ratios among thicknesses of respective layers, and the like are different from actual ones. Therefore, specific thicknesses and dimensions should be determined in consideration of the following description. It should also be noted that the drawings include portions having different dimensional relationships and ratios from one another among the drawings.

Further, the embodiment, which will be described below, indicates a device and a method to embody the technical idea of the present invention by way of example, and the technical idea of the present invention does not limit the materials, shapes, structures, arrangements, and the like of the constituent components to those described below. The technical idea of the present invention can be subjected to a variety of alterations within the technical scope prescribed by the claims described in CLAIMS.

It is noted that terms indicating directions, such as “upper”, “lower”, “left”, and “right”, that are referred to in the following description are used referring to the directions in the accompanying drawings.

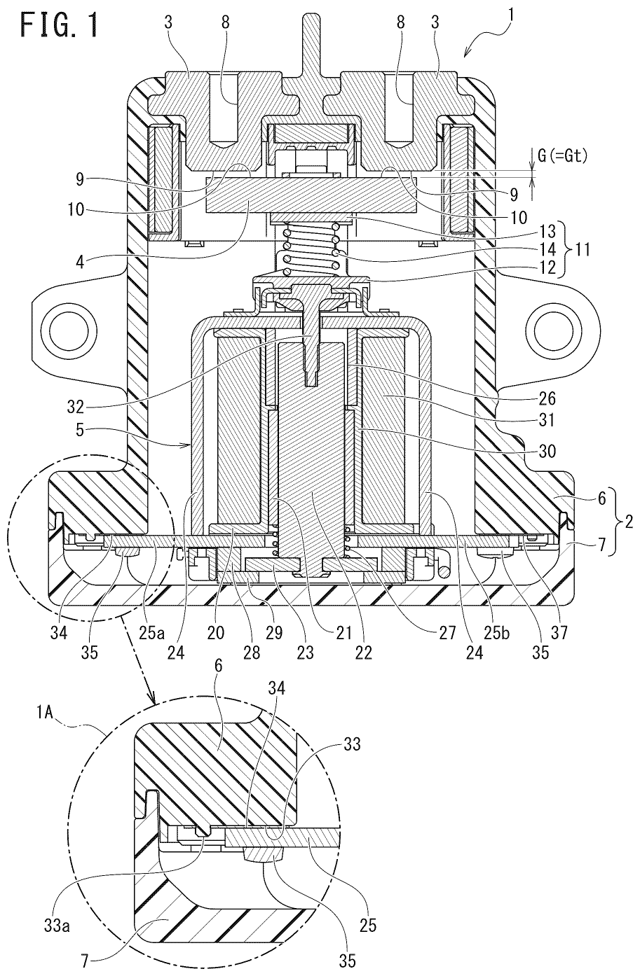

FIG. 1 is a diagram illustrative of an electromagnetic contactor 1 of a first embodiment according to the present invention.

The electromagnetic contactor 1 is a hermetically sealed high voltage contactor that opens and closes a main circuit, using an electromagnetic force. The electromagnetic contactor includes a hermetically sealed container 2 made of electrically insulating resin, a pair of fixed contact pieces 3, a movable contact piece 4, and an electromagnet unit 5, which are housed in the hermetically sealed container 2. The electromagnet unit 5 drives the movable contact piece 4 in a direction in which the movable contact piece 4 comes into contact with and is separated from the pair of fixed contact pieces 3.

The hermetically sealed container 2 includes a capsule case 6 and a capsule cover 7.

The capsule case 6 is a member formed in a square cylinder shape that has the lower end (one end) opened and the upper end (the other end) closed in FIG. 1. The capsule cover 7 is a lid-shaped member. The lower end of the capsule case 6 and the capsule cover 7 have open ends thereof fitted to each other and are fastened by a not-illustrated tapping screw.

The pair of fixed contact pieces 3 are electrodes that are made of a conductive metal and each of which is formed in a substantially columnar shape, and are integrated with the capsule case 6 by insert molding while penetrating through a wall portion of the capsule case 6. On an upper portion of each of the pair of fixed contact pieces 3, a screw hole 8 is formed and is exposed to the outside of the capsule case 6. Into the screw holes 8, terminal screws (not illustrated) on the primary side and the secondary side of the main circuit are configured to be fitted. The lower sides of the pair of fixed contact pieces 3 project to the inside of the capsule case 6, and on bottom portions of the pair of fixed contact pieces 3, fixed contacts 9 are formed.

The movable contact piece 4 is made of conductive metal, is formed in a flat plate shape extending in the right-left direction in FIG. 1, and is arranged facing the pair of fixed contact pieces 3. At both ends in the right-left direction of the movable contact piece 4, a pair of movable contacts 10 that come into contact with and are separated from the fixed contacts 9 of the pair of fixed contact pieces 3 are formed.

The movable contact piece 4 is joined to the electromagnet unit 5 via a contact support 11. The contact support 11 includes a base portion 12 joined to the electromagnet unit 5, a holding member 13 configured to hold the movable contact piece 4, and a contact spring 14 configured to set a wipe amount, which will be described later, to apply contact pressure to the movable contact piece 4. The contact spring 14 is a helical compression spring, is interposed between the base portion 12 and the movable contact piece 4, and biases the movable contact piece 4 upward in FIG. 1. The contact spring 14 elastically supporting the movable contact piece 4 in this way causes contact pressure forces between the movable contacts 10 and the fixed contacts 9 to be kept constant.

The electromagnet unit 5 includes a spool 20, a sliding collar 21, a movable plunger 22, an armature 23, a pair of outer yokes 24, a pair of bottom yokes 25a and 25b, a plunger ring 26, a back spring 27, a permanent magnet 28, and an auxiliary yoke 29.

The spool 20 is a winding frame formed of an electrically insulating resin, and a coil 31 is wound around a cylindrical winding shaft 30 that extends in the up-down direction.

The sliding collar 21 is formed of an electrically insulating resin in a cylindrical shape and is inserted into the inside of the winding shaft 30 from the lower side in the up-down direction in such a manner as to be fitted in the winding shaft 30.

The movable plunger 22 is formed, as a movable iron core, in a cylindrical shape that extends in the up-down direction, and advancement and retraction in the axial direction of the movable plunger 22 are guided by the movable plunger 22 being fitted into the inside of the sliding collar 21. The movable plunger 22 has the upper side in the up-down direction joined to the base portion 12 of the contact support 11 via a joining portion 32. The armature 23 is a disk-shaped yoke and is fixed to the lower end of the movable plunger 22.

The pair of outer yokes 24 are plate-shaped yokes and are fixed on the left-hand side and the right-hand side of the winding shaft 30. The pair of bottom yokes 25a and 25b are fixed to bottom portions of the pair of outer yokes 24 while extending to the left-hand side and the right-hand side on the same extension line, respectively.

The plunger ring 26 is a cylindrical yoke extending in the up-down direction, is inserted into the inside of the winding shaft 30 from the upper side in the up-down direction in such a manner as to be fitted in the winding shaft 30, and is fixed to upper pieces of the upper portions in the up-down direction of the pair of outer yokes 24. An inner diameter of the plunger ring 26 is larger than an outer diameter of the movable plunger 22 and is set in such a manner as to keep a prescribed clearance with respect to the movable plunger 22.

The back spring 27 is a helical compression spring, is inserted onto the movable plunger 22 while being sandwiched between the armature 23 and the plunger ring 26, and biases the movable plunger 22 to the lower side in the up-down direction with respect to the spool 20.

The permanent magnet 28 is formed in a rectangular flat plate shape in which a circular hole is formed, comes into contact with bottom portions of the pair of bottom yokes 25a and 25b, and is arranged in such a manner as to surround the armature 23. The auxiliary yoke 29 is a flat plate-shaped yoke and is attached to a bottom portion of the permanent magnet 28. Note that a unit-side joining portion of the present invention corresponds to the pair of bottom yokes 25a and 25b.

Regarding the electromagnet unit 5 to which the movable contact piece 4 is joined via the contact support 11, one bottom yoke 25a of the electromagnet unit 5 comes into contact with a first case-side mounting surface 33 formed on an opening peripheral edge of a bottom portion of the capsule case 6 while sandwiching a first spacer 34, and a fixing screw 35 that penetrates through the one bottom yoke 25a is screwed into the capsule case 6, as illustrated in a main portion enlarged view designated by a reference sign 1A in FIG. 1.

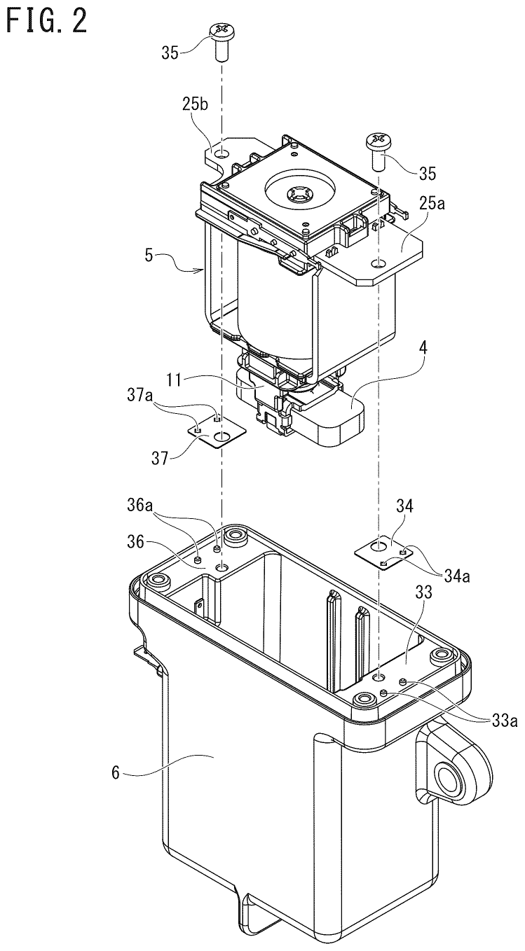

Further, as illustrated in FIG. 2, on the opening peripheral edge of the capsule case 6, a second case-side mounting surface 36 is formed at a position axisymmetric to a position of the first case-side mounting surface 33 with respect to the central axis of the capsule case 6. The other bottom yoke 25b of the electromagnet unit 5 comes into contact with the second case-side mounting surface 36 while sandwiching a second spacer 37, and another fixing screw 35 that penetrates through the other bottom yoke 25b is screwed into the capsule case 6. Note that a second surface and a container-side joining portion of the present invention correspond to the first case-side mounting surface 33 and the second case-side mounting surface 36.

By causing the pair of bottom yokes 25a and 25b to come into contact with the first case-side mounting surface 33 and the second case-side mounting surface 36 formed on the opening peripheral edge of the capsule case 6 via the first spacer 34 and the second spacer 37, respectively and screwing the fixing screws 35 that penetrate through the pair of bottom yokes 25a and 25b into the capsule case 6, the electromagnet unit 5 is assembled to the capsule case 6.

As illustrated in FIG. 2, positioning protrusions 33a and 36a are formed on the first case-side mounting surface 33 and the second case-side mounting surface 36, respectively, and positioning holes 34a and 37a are formed in the first spacer 34 and the second spacer 37, respectively. When the first spacer 34 and the second spacer 37 are arranged on the first case-side mounting surface 33 and the second case-side mounting surface 36, positioning of the first spacer 34 and the second spacer 37 is performed by causing the positioning protrusions 33a and 36a to be fitted into the positioning holes 34a and 37a, respectively.

When the above-described electromagnetic contactor 1 is in a non-excited state in which current is not applied to the coil 31 of the electromagnet unit 5, the movable plunger 22 is displaced to the lower side by magnetic force of the permanent magnet 28 and a repulsive force of the back spring 27 and the armature 23 is attracted and stuck to the auxiliary yoke 29. Since on this occasion, the contact support 11 is also displaced to the lower side, the movable contacts 10 are separated from the pair of fixed contacts 9 and the electromagnetic contactor 1 is thereby brought into a cut-off state.

In contrast, when the electromagnetic contactor 1 is in a state in which the electromagnet unit 5 is excited by applying current to the coil 31 of the electromagnet unit 5, the armature 23 being attracted and stuck to the bottom yokes 25 causes the movable plunger 22 to be displaced to the upper side against the magnetic force of the permanent magnet 28 and the repulsive force of the back spring 27. Since on this occasion, the contact support 11 is also displaced to the upper side, the movable contacts 10 come into contact with the pair of fixed contacts 9 and the electromagnetic contactor 1 is thereby brought into a closed state.

In this configuration, in the electromagnetic contactor 1 of the present embodiment, thicknesses T of the first spacer 34 and the second spacer 37 are adjusted in such a way that an inter-contact gap G between the fixed contacts 9 and the movable contacts 10 when the electromagnetic contactor 1 is in the cut-off state coincides with a target value Gt. Note that the target value Gt is an inter-contact gap at which breaking performance and vibration resistance and impact resistance of the electromagnetic contactor 1 can be improved.

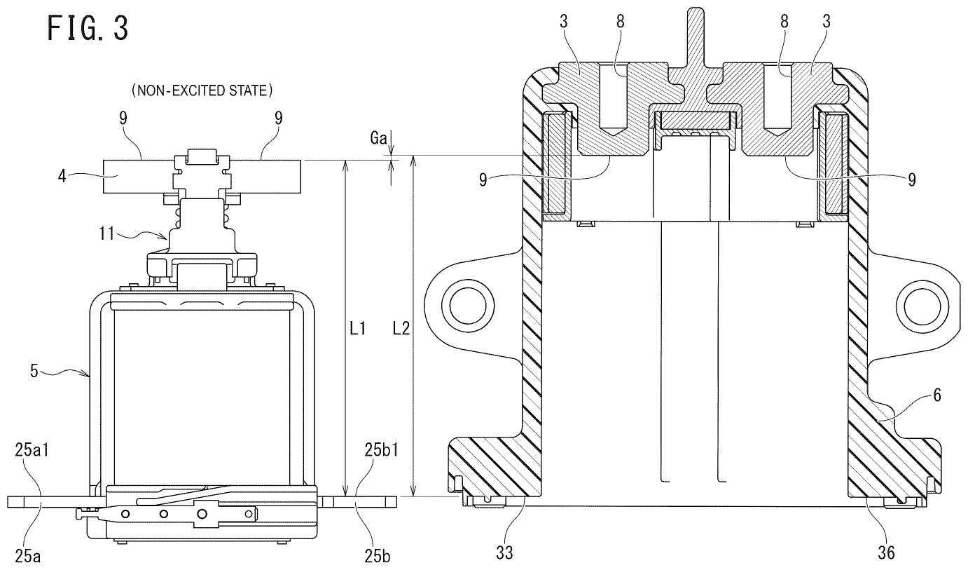

Next, a process of adjusting the inter-contact gap G of the electromagnetic contactor 1 of the present embodiment will be described with reference to FIGS. 2 and 3.

First, as illustrated in FIG. 3, using a measuring instrument, such as a laser displacement meter, first distance L1 between a contact surface 25b1 of the other bottom yoke 25b of the electromagnet unit 5 with which the second spacer 37 comes into contact and the movable contacts 10 when the electromagnet unit 5 is in the non-excited state is measured. It is noted that a dimension between a contact surface 25al of the one bottom yoke 25a of the electromagnet unit 5 with which the first spacer 34 comes into contact and the movable contacts 10 is the same dimension (first distance L1).

Further, using the measuring instrument, such as the laser displacement meter, second distance L2 between the first case-side mounting surface 33 of the capsule case 6 and the fixed contacts 9 of the fixed contact pieces 3 is measured. Note that a dimension between the second case-side mounting surface 36 and the fixed contacts 9 of the fixed contact pieces 3 is the same dimension (second distance L2). It is noted that a first surface of the present invention corresponds to the contact surfaces 25a1 and 25b1.

The second distance L2 is set to a larger value than the first distance L1. An inter-contact gap Ga when no adjustment is made is calculated by subtracting the first distance L1 from the second distance L2, as expressed by the equation (1) below.

$$Ga = L 2 - L 1 \qquad ( 1 )$$

Next, as expressed by the equation (2) below, an insufficient gap amount Gn is calculated by subtracting the inter-contact gap Ga when no adjustment is made from the target value Gt.

$$Gn = Gt - Ga \qquad ( 2 )$$

Next, a first spacer 34 and a second spacer 37 that have the same thickness T as the insufficient gap amount Gn are selected.

As illustrated in FIG. 2, the first spacer 34 and the second spacer 37 having the same thickness as the insufficient gap amount Gn are arranged on top of the first case-side mounting surface 33 and the second case-side mounting surface 36 of the capsule case 6, respectively. Next, assembling the electromagnet unit 5 to the capsule case 6 by arranging the one bottom yoke 25a and the other bottom yoke 25b of the electromagnet unit 5 on top of the first spacer 34 and the second spacer 37, respectively and screwing the fixing screws 35 causes the inter-contact gap G between the fixed contacts 9 and the movable contacts 10 to be adjusted to the target value Gt (see FIG. 1).

Therefore, in the electromagnetic contactor 1 of the present embodiment, by only selecting the first distance L1 of the electromagnet unit 5 in the non-excited state and the second distance L2 of the capsule case 6 and the first spacer 34 and the second spacer 37 having a thickness that causes the inter-contact gap G to coincide with the target value Gt, adjustment of the inter-contact gap G is completed by a simple mounting operation even when some variation exists in dimensions of constituent components of the movable contact piece 4, the contact support 11, and the electromagnet unit 5. Thus, reduction in a manufacturing cost of the electromagnetic contactor 1 can be achieved.

Next, a process of calculating a stroke amount S and a wipe amount W of the electromagnetic contactor 1 of the present embodiment will be described.

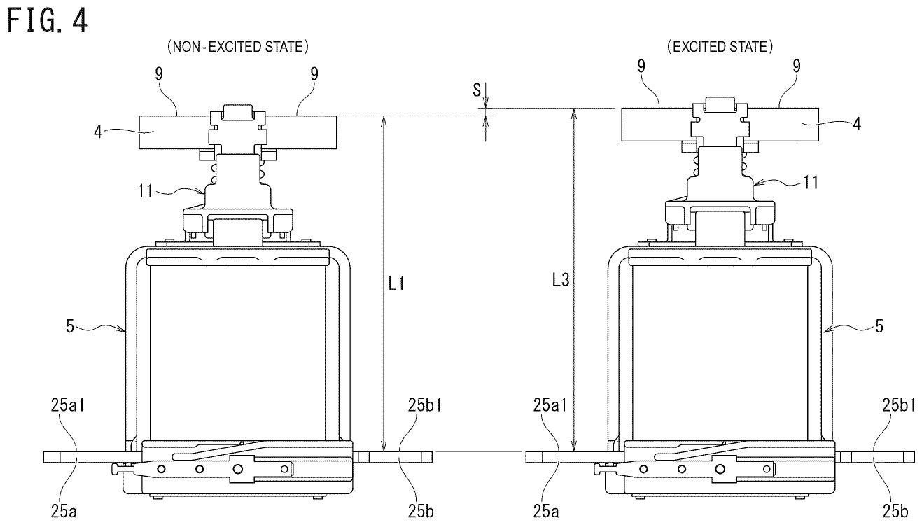

As illustrated in the right-hand side drawing in FIG. 4, using the measuring instrument, such as the laser displacement meter, third distance L3 between the contact surface 25al of the one bottom yoke 25a of the electromagnet unit 5 in the excited state and the movable contacts 10 is measured.

As expressed by the equation (3) below, the stroke amount S of the electromagnetic contactor 1 is calculated by subtracting the first distance L1 (in a state that the electromagnet unit 5 is not excited) from the third distance L3.

$$S = L 3 - L 1 \qquad ( 3 )$$

On the other hand, the wipe amount W of the contact spring 14 of the contact support 11 that applies contact pressure to the movable contact piece 4 when the movable contacts 10 come into contact with the pair of fixed contacts 9 and the electromagnetic contactor 1 is thereby brought into the closed state is calculated by subtracting the inter-contact gap G from the stroke amount S, as expressed by the equation (4) below.

$$W = S - G \qquad ( 4 )$$

Therefore, regarding the electromagnetic contactor 1 of the present embodiment, by a simple operation of only calculating the first distance L1 of the electromagnet unit 5 in the non-excited state, the third distance L3 of the electromagnet unit 5 in the excited state, and the inter-contact gap G, the stroke amount S and the wipe amount W can be easily calculated.

### REFERENCE SIGNS LIST

1 Electromagnetic contactor
2 Hermetically sealed container
3 Fixed contact piece
4 Movable contact piece
5 Electromagnet unit
6 Capsule case
7 Capsule cover
8 Screw hole
9 Fixed contact
10 Movable contact
11 Contact support
12 Base portion
13 Holding member
14 Contact spring
20 Spool
21 Sliding collar
22 Movable plunger
23 Armature
24 Outer yoke
25a, 25b Bottom yoke
26 Plunger ring
27 Back spring
28 Permanent magnet
29 Auxiliary yoke
30 Winding shaft
31 Coil
32 Joining portion
33 First case-side mounting surface
33a, 36a Positioning protrusion
34 First spacer
34a, 37a Positioning hole
35 Fixing screw
36 Second case-side mounting surface
37 Second spacer
G Inter-contact gap
Gt Target value of the inter-contact gap
Ga Inter-contact gap when no adjustment is made
Gn Insufficient gap amount
L1 First distance
L2 Second distance
L3 Third distance
S Stroke amount
W Wipe amount

1. An electromagnetic contactor comprising:
a container provided with a container-side joining portion;
a fixed contact piece having a fixed contact and arranged in the container;
a movable contact piece having a movable contact which comes into contact with, and is separated from, the fixed contact and arranged in the container;
an electromagnet unit operatively joined to the movable contact via a contact support and arranged in the container, wherein the electromagnet unit is provided with a unit-side joining portion joined to the container-side joining portion in a direction of movement of the movable contact; and
a spacer arranged between the container-side joining portion and the unit-side joining portion to adjust an inter-contact gap between the fixed contact and the movable contact.

2. The electromagnetic contactor according to claim 1, wherein
the container includes a cylindrical capsule case which has one end opened and the other end closed, and a capsule cover configured to cover the one end of the capsule case,
the fixed contact piece is integrally formed with the other end of the capsule case such that the fixed contact projects to an inside of the capsule case,
the container-side joining portion is a case-side mounting surface formed on a peripheral edge of an open end of the capsule case, and
the spacer is arranged interposed between the case-side mounting surface and the unit-side joining portion.

3. The electromagnetic contactor according to claim 1, wherein
assuming that a distance between a first surface of the unit-side joining portion and the movable contact in the direction of movement of the movable contact piece in a state that the electromagnet unit is not excited is first distance L1, a distance between a second surface of the container-side joining portion and the fixed contact in the direction of movement of the movable contact piece is second distance L2, and a target value of an inter-contact gap is denoted by Gt,
thickness T of the spacer is determined by an equation (a) below:
$$T = Gt - ( L 2 - L 1 ) . \qquad ( a )$$

4. A method of adjusting an inter-contact gap in an electromagnetic contactor which includes a fixed contact piece and an electromagnet unit operatively jointed to a movable contact piece, the method comprising:
measuring, in a state that the electromagnet unit is not excited, first distance L1 in a direction of movement of the movable contact piece and between a first surface of a unit-side joining portion of the electromagnet unit and a movable contact of the movable contact piece;
measuring second distance L2 in the direction of movement of the movable contact piece and between a second surface of a container-side joining portion and a fixed contact of the fixed contact piece, the container-side joining portion being arranged on a container configured to contain the fixed contact piece, the movable contact piece, and the electromagnet unit;
providing a spacer having thickness T determined by an equation (a) below:
$$T = Gt - ( L 2 - L 1 ) , \qquad ( a )$$
where Gt is a target value of an inter-contact gap between the fixed contact and the movable contact; and
joining the container-side joining portion and the unit-side joining portion by interposing the spacer determined to thickness T.

5. A method of calculating a stroke amount of an electromagnetic contactor, the method comprising:
measuring the first distance L1 by the method according to claim 4; and
before joining the electromagnet unit to the container, measuring, in a state that the electromagnet unit is excited, third distance L3 between the first surface of the unit-side joining portion, and the movable contact in a direction of movement of the movable contact piece; and calculating stroke amount S by an equation (b) below:
$$S = L 3 - L 1. \qquad ( b )$$

6. A method of calculating a wipe amount of an electromagnetic contactor, the method comprising:
measuring, in a state that the electromagnet unit is not excited, first distance L1 in a direction of movement of the movable contact piece and between a first surface of a unit-side joining portion of the electromagnet unit and a movable contact of the movable contact piece;
measuring second distance L2 in the direction of movement of the movable contact piece and between a second surface of a container-side joining portion and a fixed contact of the fixed contact piece, the container-side joining portion being arranged on a container configured to contain the fixed contact piece, the movable contact piece, and the electromagnet unit;
determining thickness T of a spacer to be arranged between the container-side joining portion and the unit-side joining portion by an equation (a) below:
$$T = Gt - ( L 2 - L 1 ) , \qquad ( a )$$
where Gt is a target value of an inter-contact gap between the fixed contact and the movable contact;
before joining the electromagnet unit to the container, measuring, in a state that the electromagnet unit is excited, third distance L3 between the first surface of the unit-side joining portion, and the movable contact in a direction of movement of the movable contact piece;
calculating stroke amount S by an equation (b) below:
$$S = L 3 - L 1 ; and \qquad ( b )$$
calculating wipe amount W by an equation (c) below:
$$W = S - Gt . \qquad ( c )$$
